(19) United States
(12) Patent Application Publication
(10) Pub. No.: US 2014/0236844 A1
(43) Pub. Date: Aug. 21, 2014

(54) Systems and Methods for Product Event Management

(71) Applicants: Wen-Long Ronnie Shaw, Reston, VA (US); Matthew Kendell Salter, Falls Church, VA (US)

(72) Inventors: Wen-Long Ronnie Shaw, Reston, VA (US); Matthew Kendell Salter, Falls Church, VA (US)

(73) Assignee: Noblis, Inc., Falls Church, VA (US)

(21) Appl. No.: 13/772,826

(22) Filed: Feb. 21, 2013

(51) Int. Cl. G06Q 30/00

(52) U.S. Cl. CPC G06Q 30/014
USPC 705/303

(57) ABSTRACT

A system for processing and managing product events is disclosed. The system may include one or memories storing instructions and one or more processors configured to execute the instructions to perform certain operations. The operations performed by the processors may include receiving a first product alert corresponding to a product event, wherein the product event is one of a recall event, a field correction event, or a repair instructions event, and receiving a second product alert. The operations may also include determining that the second product alert also corresponds to the product event, and responsive to determining that the second product alert also corresponds to the product event, generating an event data entry that represents the product event and includes the first product alert and the second product alert.

### TECHNICAL FIELD

Disclosed embodiments relate generally to product event management. More specifically, disclosed embodiments relate to apparatus and processes for managing product events, such as a recall event, a field correction event, or a repair instructions event, and for managing the product alerts that are associated with the product events.

### BACKGROUND

Products of all varieties may experience defects or problems that interfere with a customer's use of those products. For example, defects may cause safety concerns and/or may otherwise affect the functionality, aesthetics, etc., of the product. In many situations, it is important for the customer to be aware of the defects or other problems associated with the product.

Thus, when an alerting entity (e.g., a product manufacturer, a product distributor, a governmental agency, a consumer group, etc.) learns that a product is defective, the alerting entity may issue one or more product alerts to notify customers and other entities within the supply chain to stop using the product, return the product, etc. In many situations, multiple alerting entities may each issue product alerts for the same defective product. For example, the product manufacturer of a defective product may issue a product alert and may additionally or alternatively notify one or more governmental agencies or consumer groups, which may also issue product alerts.

Moreover, the alerting entities may issue these product alerts (and updates to the product alerts) to customers in a piecemeal fashion as the alerting entities receive additional information about the defective product. For example, an alerting entity may initially determine that Brand X surgical gloves manufactured in Lot 1 are defective and issue a product alert recalling those gloves. Subsequently, the alerting entity may determine that Brand X surgical gloves manufactured in Lot 2 are also defective and may issue a separate product alert. The alerting entity may continue issuing subsequent alert updates as it uncovers additional information about the defective product.

Customers may be inundated with product alerts because they may be receiving alerts from multiple alerting entities and each alerting entity may issue multiple product alerts for a particular defective product. Moreover, because of the piecemeal, unorganized receipt of these product alerts, customers may be unable to effectively track their progress in processing and responding to them. For example, over time, a customer may receive multiple product alerts related to the same defective product, but the customer may not have the capabilities to organize and process the related alerts in an organized fashion.

### SUMMARY

Systems and methods consistent with disclosed embodiments include apparatuses and processes that enable users to manage related product alerts and alert updates together at the product event level. A product event may represent, for example, one or more of a recall event when a product is being recalled, a field correction event when corrections to the product or its use can be made without the need to recall the product, or a repair instructions event when instructions for repairing the product are provided to the user. As discussed above, an alerting entity may release multiple alerts for a single product event. The systems and methods disclosed herein may facilitate a user in processing and responding to the multiple product alerts that they receive by determining related product alerts that correspond to the same product event, generating an event data entry that represents the product event, and enabling the user to process and respond to the related product alerts together through the event data entry.

Certain disclosed embodiments include a system for processing and managing product events. The system may include one or memories storing instructions and one or more processors configured to execute the instructions to perform certain operations. The operations performed by the processors may include receiving a first product alert corresponding to a product event, wherein the product event is one of a recall event, a field correction event, or a repair instructions event, and receiving a second product alert. The operations may also include determining that the second product alert also corresponds to the product event, and responsive to determining that the second product alert also corresponds to the product event, generating an event data entry that represents the product event and includes the first product alert and the second product alert.

Other disclosed embodiments include a computer-implemented method for processing and managing product events. The method may include receiving, by one or more processors, a first product alert corresponding to a product event, wherein the product event is one of a recall event, a field correction event, or a repair instructions event, and receiving, by the one or more processors, a second product alert. The method may also include determining, by the one or more processors, that the second product alert also corresponds to the product event, and responsive to determining that the second product alert also corresponds to the product event, generating, by the one or more processors, an event data entry that represents the product event and includes the first product alert and the second product alert.

Still other disclosed embodiments include a system for processing and managing product events, comprising one or memories storing instructions, and one or more processors configured to execute the instructions to perform certain operations. The operations may include determining that each of a plurality of product alerts corresponds to a same product event, wherein the product event is one of a recall event, a field correction event, or a repair instructions event, and generating an event data entry that represents the product event and includes the plurality of product alerts. The operations may further include providing data to generate a graphical user interface (GUI) that displays the event data entry and enables a user to update a workflow associated with each of the plurality of product alerts, wherein the GUI updates a displayed status of the event data entry based on updates to the workflow associated with each of the plurality of product alerts.

Additional objects and advantages of disclosed embodiments will be set forth in part in the description that follows, and in part will be obvious from the description, or may be learned by practice of the disclosed embodiments. The objects and advantages of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate several embodiments and together with the description, serve to explain the principles of the disclosed embodiments. In the drawings:

FIG. 1 is block diagram illustrating an exemplary system for processing and managing product events in accordance with certain disclosed embodiments;

FIG. 2 is a flow chart illustrating an exemplary method for processing and managing product events that may be performed by the system of FIG. 1;

FIG. 3 is a screen shot of an exemplary GUI that may be generated by the system of FIG. 1;

FIG. 4 is a flow chart illustrating an exemplary method for managing product events that may be performed by the system of FIG. 1;

FIG. 5 is a screen shot of an exemplary GUI that may be generated by the system of FIG. 1;

FIG. 6 is another screen shot of an exemplary GUI that may be generated by the system of FIG. 1;

FIG. 7 is another screen shot of an exemplary GUI that may be generated by the system of FIG. 1; and

FIG. 8 is another screen shot of an exemplary GUI that may be generated by the system of FIG. 1.

### DETAILED DESCRIPTION OF THE EMBODIMENTS

Reference will now be made in detail to exemplary disclosed embodiments, examples of which are illustrated in the accompanying drawings. Wherever possible, the same reference numbers will be used throughout the drawings to refer to the same or like parts. While several exemplary embodiments and features are described herein, modifications, adaptations, and other implementations are possible, without departing from the spirit and scope of the disclosed embodiments. Accordingly, the following detailed description does not limit the disclosed embodiments. Instead, the proper scope of the disclosed embodiments is defined by the appended claims.

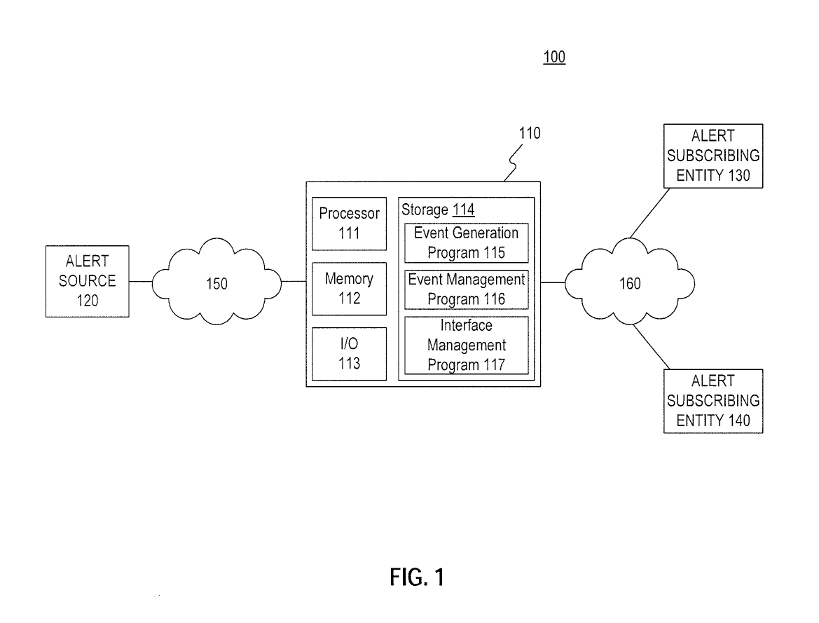

FIG. 1 is a block diagram illustrating an exemplary system 100 for processing and managing product events. System 100 may include a product event manager 110 communicatively connected to an alert source 120 via a network 150 and communicatively connected to alert subscriber entities 130 and 140 via a network 160. As discussed in greater detail with regard to the exemplary embodiments below, product event manager 110 may receive product alerts from alert source 120, determine a plurality of product alerts that correspond to a single product event, generate an event data entry that represents the product event and includes the plurality of product alerts, and provide data to generate a GUI at computing devices of alert subscribing entities 130 and 140. The GUI may display the event data entry and enable a user to interact with the event data entry to update workflows associated with each of the plurality of product alerts included in the event data entry. Product event manager 110 may also update various aspects of the event data entry based on the user's updates to the product alert workflows, as discussed in greater detail below. These updates to the events may also be displayed in the GUI. This way, the user may more effectively manage related product alerts at the product event level and may be presented with a clear picture, through the GUI, of the progress made and remaining steps required to process all product alerts associated with a product event.

In certain embodiments, alert source 120 represents a wide variety of geographically distributed sources that provide product alerts to product event manager 110 across a wide variety of formats. For example, alert source 120 may include one or more websites or databases that include product alerts and are managed by one or more alerting entities (e.g., product manufacturer, product distributor, governmental agency, consumer group, etc.). Alert source 120 may also include one or more communications received from an alerting entity, such as a product recall notice, that may be received by product event manager 110 in electronic or paper format.

Alert subscribing entities 130 and 140 may subscribe to system 100 for receiving product alert and product event information. Alert subscribing entities 130 and 140 may be any organization that may receive, manage, and/or respond to product alerts using system 100. In one example, alert subscribing entities 130 and 140 may be hospitals or medical centers, and may receive product alerts related to products in various domains, such as biomedical devices, blood products, children's consumer products such as toys, food, laboratory products, medical supplies, pharmaceutical products, radiology products, tissues and organs, engineering and facilities related products and devices, and healthcare related hardware and software. Of course, the product alerts processed and managed by system 100 can be associated with any industry and are not limited to the medical industry. In certain embodiments, alert subscribing entities 130 and 140 may include a number of facilities, and each facility may receive product alerts and product events that may be relevant to its functions only. For example, a facility with a pharmacy department may be interested in receiving product recall alerts in pharmaceutical products while a facility without a pharmacy department may not.

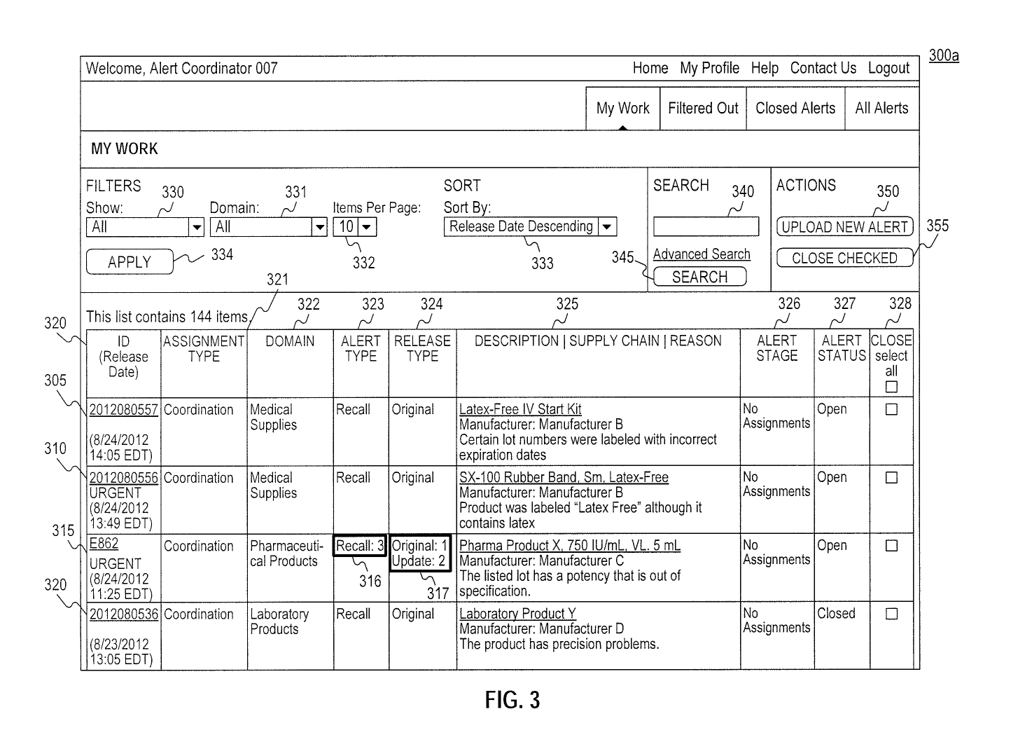

Alert subscribing entities may receive the product alert and product event information from product event manager 110 via network 160. To this end, product event manager 110 may generate and send data via network 160 for displaying a GUI at one or more electronic devices associated with alert subscribing entity 130. The GUI may be embodied, for example, as a web page, as an application (e.g., an “app”) installed on one or more of the electronic devices, etc. As discussed in greater detail with regard to the embodiments below, the GUI may also enable a user to generate and send requests, commands, and other information related to one or more product alerts and/or product events to product event manager 110. Responsive to receiving and processing this information, product event manager 110 may generate data for displaying the results of the processing via the GUI. Screen shots of exemplary GUIs are discussed below with respect to FIGS. 3 and 5-8.

As shown in FIG. 1, product event manager 110 may include a processor 111, a memory 112, input/output devices 113, and a storage 114. Processor 111 may include one or more processing devices, such as a microprocessor, microcontroller, laptop computer, desktop computer, server, workstation, etc. Memory 112 may include one or more storage devices configured to store information that is used by processor 111 and/or other entities internal and external to product event manager 110. For example, memory module 112 may store one or more programs that, when loaded from storage 114 and executed by processor 111, enable processor 111 to receive and process product alerts, identify product alerts that correspond to a similar product event, and generate data for displaying a GUI that enables a user to manage product alerts at the product event level. Input/output devices 113 may be one or more devices that facilitate the transfer of information between product event manager 110 and external components, such as alert source 120, alert subscription entities 130 and 140, and/or one or more other devices or users associated with product event manager 110. For example, input/output devices 113 may include an administrative interface for managing and maintaining product event manager 110.

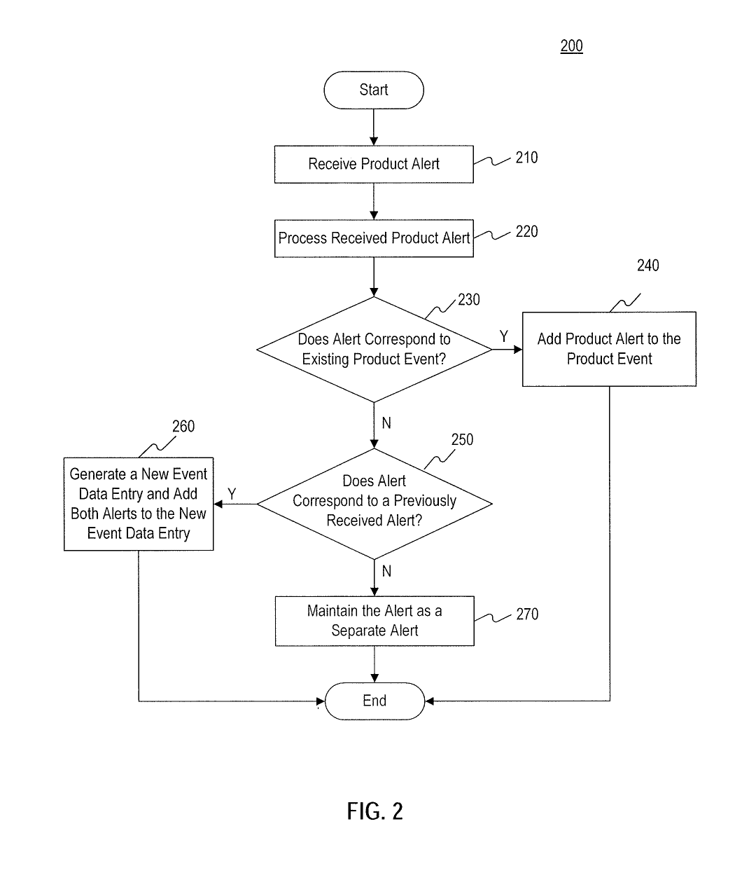

Storage 114 may include one or more programs or subprograms that, when executed by processor 111 (e.g., after being loaded into memory 112), enable product event manager 110 to perform certain functions related to disclosed embodiments. For example, storage 114 may include one or more event generation programs 115, one or more event management programs 116, one or more interface management programs 117, and other programs or subprograms that enable product event manager 110 to receive product alerts from alert source 120, determine a plurality of product alerts that correspond to a single product event, generate an event data entry that represents the product event and includes the plurality of product alerts, and provide data to generate a GUI for alert subscribing entities 130 and 140. The GUI may display the event data entry and enable a user to interact with the event data entry to update workflows associated with each of the plurality of product alerts included in the event data entry. These functions are discussed in greater detail below with regard to FIGS. 2-8.

Moreover, while product event manager 110 is shown in FIG. 1 as a single device, this architecture is exemplary only. Those skilled in the art will appreciate that product event manager 110 may include any number of computing devices, such as one or more computers, servers, etc., that may cooperate to perform the functions described herein with respect to product event manager 110. For example, product event manager 110 may be configured as a distributed system with a plurality of components distributed in remote locations and interconnected by communication paths, such as local area networks, wide area networks, and any other type of network that may facilitate communications and the exchange of information between the components.

Networks 150 and 160 may include any one of or combination of wired or wireless networks. For example, network 150 may include wired networks such as twisted pair wire, coaxial cable, optical fiber, and/or a digital network. Likewise, network 150 may include any wireless networks such as RFID, microwave or cellular networks or wireless networks employing, e.g., IEEE 802.11 protocols. Additionally, network 150 may be integrated into any local area network, wide area network, campus area network, or the Internet.

FIG. 2 is a flow chart illustrating an exemplary method 200 for processing and managing product alerts and product events that may be performed by product event manager 110, for example, by executing event generation program 115 and/or other programs associated with product event manager 110. In method 200, product event manager 110 may receive a product alert, e.g., from alert source 120 (Step 210). For example, product event manager 110 may receive the product alert as information from a web page or database associated with an alerting entity, as a product recall issued and sent from a manufacturer or distributor of a product, or in any other format in which alert source 120 may include the product alert.

Upon receiving the product alert, product event manager 110 may process the product alert (Step 220). Processing the product alert may include generating an alert data entry from the received data associated with the alert. The alert data entry may include a standard format so that all product alerts processed and managed by product event manager 110 are stored in the same format. For example, product event manager 110 may assign a product alert identifier to the received product alert. In certain embodiments, the product alert identifier may be a numeric identifier that includes an indication of the date that the product alert was received and/or issued. For example, a product alert received in August, 2012 may be assigned a product alert identifier of 201208####, where “201208” represents the month and year the alert was received and #### is a numeric sequence for all of the alerts received in that month. This format, of course, is exemplary only, and any format may be used for the product alert identifier.

Product event manager 110 may perform additional processing on the received product alert to determine and/or extract data from the received product alert. In certain embodiments, product event manager 110 may classify the product alert into one of a predetermined group of domains. For example, in the healthcare industry, product event manager 110 may classify the product alert into exemplary domains such as biomedical devices, blood products, children's consumer products, food, laboratory products, medical supplies, pharmaceutical products, radiology products, tissues and organs, engineering and facilities related products and devices, healthcare related hardware and software, etc. Product event manager 110 may also extract additional information when processing the product alert, such as the alert type (e.g., product recall, field correction, repair instructions, etc.), the release type (e.g., whether the alert is an original alert or an update to a previous alert), a description of the alert, an identification of the product's supply chain, whether the alert is an urgent alert, etc. This processed information may be stored at product event manager 110 or elsewhere as an alert data entry, which, as discussed above, may be represented in a standard format, so that all product alerts managed by product event manager 110 are represented in a similar manner.

Product event manager 110 may perform the processing described above automatically, e.g., by processing the data included in the product alert and referencing one or more relational or rules databases for identifying, determining, and extracting the information. In certain embodiments, product event manager 110 may process portions of the information discussed above automatically and other portions may be processed and/or confirmed by a human administrator of product event manager 110, e.g., via input/output devices 113.

Product event manager 110 may determine if there are previously received and processed product alerts and/or product events that correspond to the product alert that was processed in Step 220. For example, in Step 230, product event manager 110 may determine whether the product alert corresponds to an already existing product event represented by product event manager 110 as an event data entry. As discussed above, alerting entities may issue multiple product alerts for a single product event. Product event manager 110 enables a user to process and manage the multiple alerts together as a product event by generating and maintaining an event data entry for each product event. The generation of an event data entry is discussed in greater detail below with regard to Step 260.

If product event manager 110 determines that the product alert corresponds to an already existing product event (Step 230, Y), product event manager 110 may add the product alert to the product event, e.g., by associating the alert data entry with the event data entry. For example, consider a product recall of Brand X surgical gloves where two or more product alerts have been previously received by product event manager 110 regarding the product recall. A first original product alert may have been received and processed by product event manager 110, and then a second alert updating the original product alert may have been received. Product event manager 110 may have previously determined (e.g., by method 200) that these product alerts were related to the same product event (i.e., the recall of Brand X surgical gloves) and generated an event data entry representing the product event. If, at Step 230, product event manager determines that the product alert received in step 210 is also related to the Brand X surgical glove product event, product event manager 110 adds the product alert to the existing event data entry, e.g., by associating the alert data entry corresponding to the product alert with the event data entry corresponding to the original recall of Brand X surgical gloves. This way, the user may view and manage all of the related product alerts that are part of the same product event at the product event level instead of the individual product alert level.

If product event manager 110 determines that the product alert does not correspond to an existing product event (Step 230, N), product event manager 110 may determine whether the product alert corresponds to a previously received product alert for which an event data entry has not yet been created (Step 250). Continuing with the Brand X surgical glove recall example, product event manager 110 may have previously received an original product alert regarding the recall. At Step 250, product event manager 110 may determine that the product alert received at Step 210 is related to that original product alert (e.g., it is an update to the original product alert), even though product event manager 110 has not yet created an event data entry (Step 250, Y). Responsive to this determination, product event manager 110 may generate a new event data entry representing the product event and add both product alerts to the new event data entry, e.g., by associating the alert data entries with the newly created event data entry.

Similar to an alert data entry, an event data entry may be represented in a standard format so that all product events processed and managed by product event manager 110 are stored in the same format. For example, product event manager 110 may assign a product event identifier to the event data entry. In certain embodiments, the product event identifier may be represented in a format of E####, where “E” represents that it is an event data entry instead of an alert data entry and “####” is a numeric sequence for all of the event data entries generated by event generator 110. This format, of course, is exemplary only, and any format may be used for the product event identifier.

When creating the event data entry, product event manager 110 may generate data for fields similar to those included in the alert data entry, such as a domain, event type, release type, description of the event, identification of the product's supply chain, whether the event is urgent, etc. Product event manager 110 may use data from the alert data entries associated with the event data entry in order to propagate these fields. For example, if an event data entry is associated with three product alerts (one original alert and two alert updates) of the type “Recall,” then the event type may also be “Recall.” The event type may also include an indication of the number of different recall alerts included in the event, e.g., “Recall: 3” in the above example (see, e.g., alert type 316 in FIG. 3). Likewise, the release type associated with the event data entry may indicate that the event data entry includes an original alert and two updates, e.g. “Original: 1; Update: 2” (see, e.g., release type 317 in FIG. 3).

If product event manager 110 determines that the product alert does not correspond to a previously received product alert (Step 250, N), product event manager 110 may maintain the product alert as a separate product alert, e.g., by storing the alert data entry unassociated with any event data entry (Step 270).

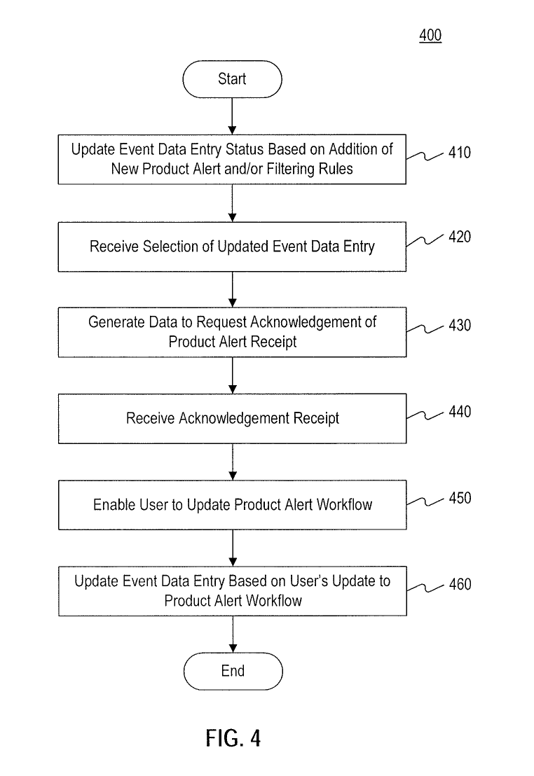

Method 200 of FIG. 2 may be repeated for each product alert received by product event manager 110. Moreover, product event manager 110 may use the data created by method 200 to generate instructions for displaying a GUI, such as those shown in FIGS. 3-4, that displays the generated alert data entries and/or event data entries.

For example, FIG. 3 illustrates a screen shot of an exemplary GUI 300a that may be generated for an electronic device associated with alert subscribing entity 130 to display product alerts and product events. GUI 300a displays three exemplary alert data entries 305, 310, and 320 as well as an exemplary event data entry 315. As shown in FIG. 3, GUI 300a may display data included in the alert data entries and event data entries such as: (1) the alert identifier or event identifier along with a release date of the alert or event in column 320, (2) the assignment type of the alert or event (e.g., a category of personnel at alert subscribing entity 130 to which the alert should be assigned for resolution, such as a coordinator, a responder, etc.) in column 321; (3) the determined domain (e.g., biomedical devices, blood products, children's consumer products, food, laboratory products, etc.), of the alert or event in column 322; (4) the alert or event type (e.g., recall, repair, etc.) in column 323; (5) the release type of the alert or event in column 324; (6) information regarding a description of the product, the product's supply chain, and/or the reason for the alert or event in column 325; (7) a stage of the alert or event (e.g., whether the alert has been assigned to a person at alert subscribing entity 130 for resolution) in column 326; and (8) an alert or event status (e.g., whether the alert or event requires additional action and is therefore “open” or whether it has been resolved and is therefore “closed”) in column 327.

GUI 300a may also include options that enable the user to change how alerts and events are displayed. For example, a user may configure GUI 300a to show only alerts or events that have been generated by one or more alerting entities and filter out alerts or events generated by other alerting entities, e.g., by making selections in drop down menu 330. Likewise, a user may configure GUI 300a to display only alerts and events that correspond to one or more particular domains and filter out alerts and events corresponding with other domains by making selections in drop down menu 331. The user may also determine how many alerts and events should be displayed on each page by making selections in drop down menu 332. Likewise, the user may choose how alerts and events should be sorted in GUI 300a, e.g., by release date descending, release data ascending, manufacturer, alert or event type, or by any other field included in the alert and event data entries. After making the selections in drop down menus 330-333, the user may select “Apply” icon 334 to apply the selections and refresh GUI 300a.

GUI 300a may also enable a user to search among the various alert and event data entries, e.g., by typing a search term in search field 340 and selecting “Search” icon 345. GUI 300a may then display the events and alerts that satisfy the search terms.

GUI 300a may also include features that enable the user to modify and/or manage alerts and events. For example, the user may have the ability to upload a new alert to product event manager 110 by selecting “Upload New Alert” icon 350 and entering alert information to be used by product event manager 110 to generate a new alert data entry. For example, responsive to receiving a selection of “Upload New Alert” icon 350, product event manager 110 may prompt the user via GUI 300a to enter data corresponding to columns 320-327, and/or any other information that may be stored as a part of an alert data entry. The user may also be able to change the status of one or more alert or event data entries to “closed” by selecting a check box in column 328 corresponding to the alert or event to be closed and then selecting “Close Checked” icon 355. In certain embodiments, the system may only allow a user to close an alert or event after receiving confirmation that the user has reviewed the alert or event, as discussed in the exemplary embodiments below.

FIG. 4 is a flow chart illustrating an exemplary method 400 for managing product events that may be performed by product event manager 110, for example, by executing event management program 116 and/or other programs associated with product event manager 110. In certain embodiments, method 400 may be performed in conjunction with method 200 of FIG. 2, e.g., after a product alert is added to an event data entry in step 240 and/or after a new event data entry is created and associated with a new product alert and a previous product alert in step 260.

Product event manager 110 may update the status (e.g., open or closed) of an event data entry based on the addition of a new product alert and by optionally referencing filtering rules associated with the new product alert (Step 410). For example, the product event related to the recall of Brand X surgical gloves may previously have been assigned a “closed” status because all product alerts associated with the event data entry had been addressed and closed. However, if a new product alert is also associated with this product event, then product event manager 110 may update the status of the event data entry to be “open” because there is now a new alert associated with the event that has not yet been closed.

In some embodiments, product event manager 110 may also determine whether the new product alert meets a set of filtering criteria that may be determined by a user or administrator for filtering out a subset of product alerts. For example, a user may use the filtering criteria to filter out product alerts from a particular alerting entity or product alerts associated with one or more products or manufacturers. If filtering criteria have been established, then at Step 410 product event manager 110 may not update the status of the event data entry if the new product alert satisfies the filtering criteria. For example, if the filtering criteria instruct product event manager 110 to filter out all alerts received from Alerting Entity A, and the new alert is from Alerting Entity A, then product event manager 110 may maintain the event data entry's status as “closed” and not change it to “open.” Moreover, in certain embodiments, product event manager 110 may still associate the filtered out alert data entry with the corresponding event data entry without updating the status of the event data entry.

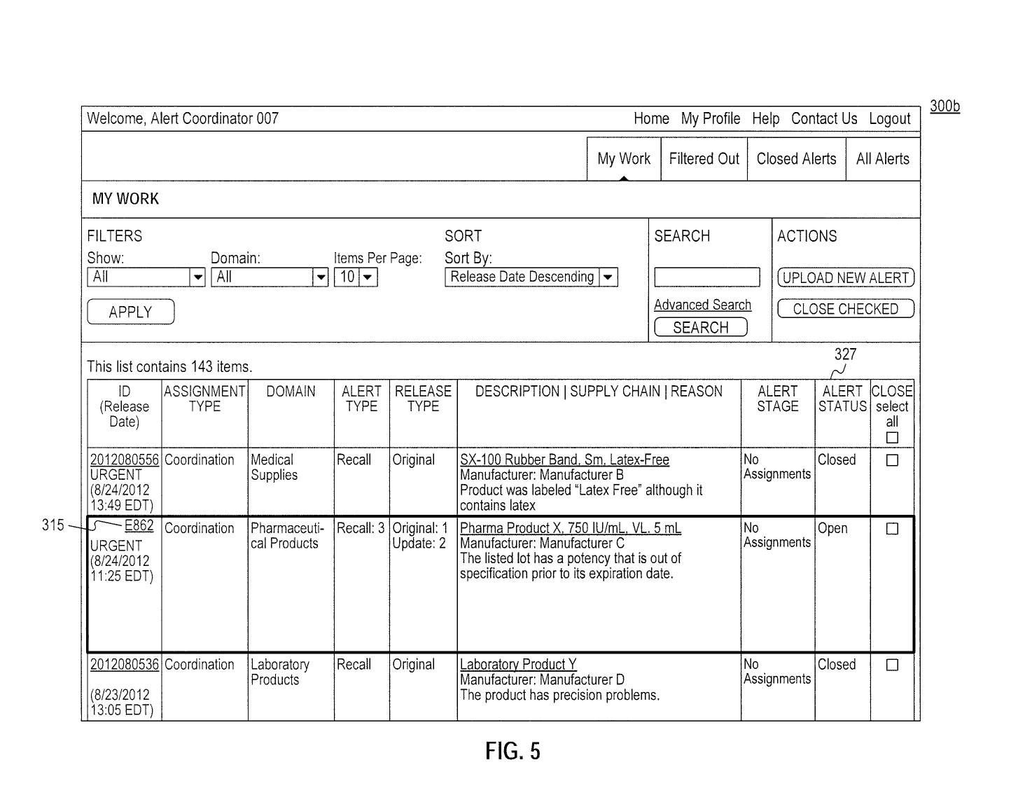

If the status of an event data entry has been changed in Step 410, a GUI may display an indication of the change to the user. For example, as shown in GUI 300b of FIG. 5, event data entry 315 may have been changed to an “open” status (see column 327) and may be displayed in a manner to distinguish it from the other data entries, e.g., by highlighting or otherwise changing a color of the cells representing event data entry 315, outlining the cells, representing the text within the cells in a different color or font, etc. This may alert the user to the changed status of event data entry 315, prompting the user to select event data entry 315 via GUI 300b to review the new product alert and/or update workflow associated with the new product alert.

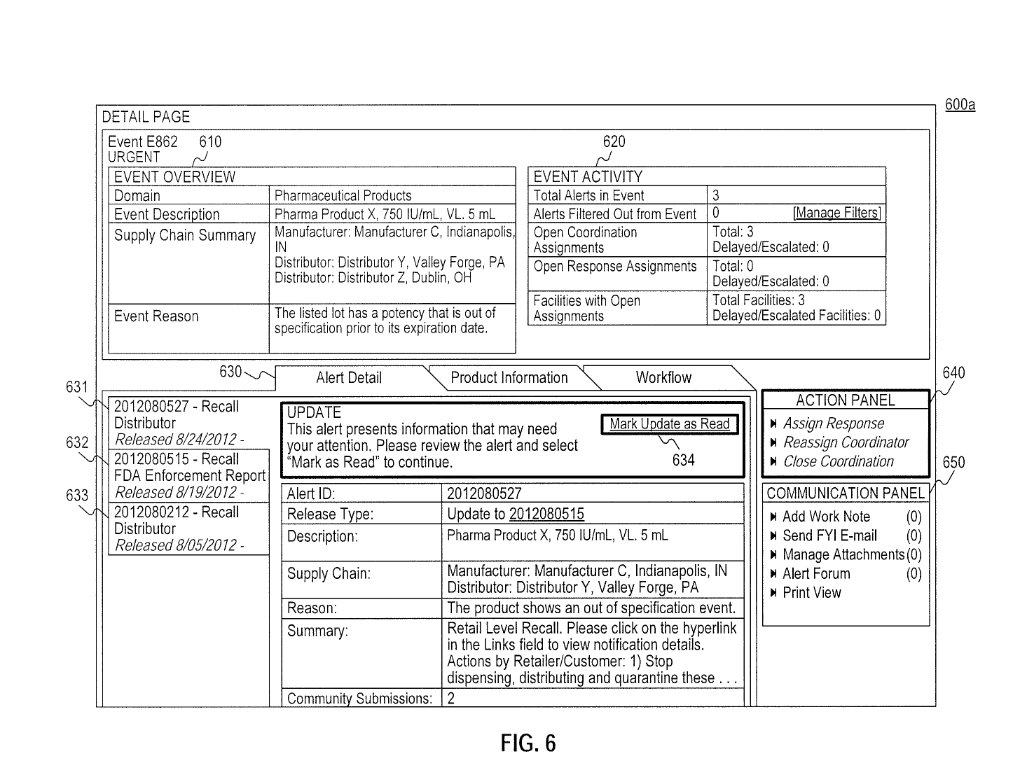

If, product event manager 110 receives, via GUI 300b, an indication that the user has selected event data entry 315, e.g., by clicking on event data entry 315 (Step 420), then product event manager 110 may generate data to request acknowledgment that the user has received and/or read the new product alert (Step 430). For example, upon receiving the selection of event data entry 315, product event manager 110 may generate data for displaying GUI 600a shown in FIG. 6, which may provide additional data related to event data entry 315, such as event overview information 610 and event activity information 620. GUI 600a may also include a list of the alert data entries 631, 632, and 633 associated with event data entry 315 and, in “Alert Detail” tab 630, a request for the user to read information related to new alert data entry 631 and then select icon 634 to indicate that the user has reviewed the alert.

A user may select icon 634 via GUI 600a to indicate that the user has reviewed the alert. Responsive to the user's selection, product event manager 110 may receive an acknowledgement receipt from the electronic device associated with the user, indicating that the user has reviewed the alert (Step 440.)

After receiving the acknowledgement receipt, product event manager 110 may generate data to enable the user to update a workflow associated with the product alert or otherwise manage different aspects of the product alert (Step 450). For example, returning to FIG. 6, GUI 600a may display an Action Panel 640 that includes actions the user may take to update the workflow of the product alert such as assigning a responsive action associated with the product alert to a responder (e.g., remove a recalled product from shelves, repair a faulty product, etc.). Action Panel 640 may also enable a user to assign a coordinator who may be responsible for overseeing the product alert and ensuring that all responsive actions are taken. Further, Action Panel 640 may enable the user to close a product alert when all responsive actions are taken. In certain embodiments, Action Panel 640 may be inaccessible (e.g., not visible, grayed out, etc.) via GUI 600a until after the user selects icon 634.

Communication Panel 650 may enable the user to manage other aspects of the product alert. For example, via Communication Panel 650, the user may add a work note providing additional details associated with a responsive action, send an e-mail to a stakeholder associated with the product alert, add, delete, or modify one or more attachments associated with the alert (e.g., the original product recall notice from the manufacturer, etc.), initiate a forum discussion regarding the alert, or print the alert.

Product event manager 110 may also update the event data entry based on the user's update to the product alert workflow in Step 450 (Step 460). For example, continuing with the Brand X surgical glove product event discussed above, at Step 410 product event manager 110 may have changed the corresponding event data entry status to “open” because it received a new product alert related to the product event. Subsequently, a user may select icon 634 in GUI 600a to indicate that the user has read the new product alert, and then perform a variety of tasks such as assigning a responsive action via Action Panel 640, tracking the status of the responsive action, and eventually closing the product alert via Action Panel 640. Responsive to the user closing the product alert via Action Panel 640, product event manager may determine that all of the product alerts associated with the Brand X surgical glove product event are now closed, and, in response, may update the status of the event data entry to “closed” (Step 460).

The process discussed above may repeat for subsequently received product alerts associated with the same product event. For example, if a subsequent product alert is received, product event manager 110 may change the product event's status to “open” and enable the user to modify a workflow associated with the subsequent product alert. Then, upon receiving instructions from the user that the subsequent product alert is closed, product event manager 110 may update the event data entry to a “closed” status.

Product event manager 110 may use the process described above to update other aspects of the event data entry based on updates to the workflow associated with underlying alerts and is not merely limited to updating the status of the event data entry. For example, product event manager may also update any of the fields represented by columns 320-327 of FIG. 3 of an event data entry based on updates to underlying product alerts and alert data entries associated with a particular product event and event data entry.

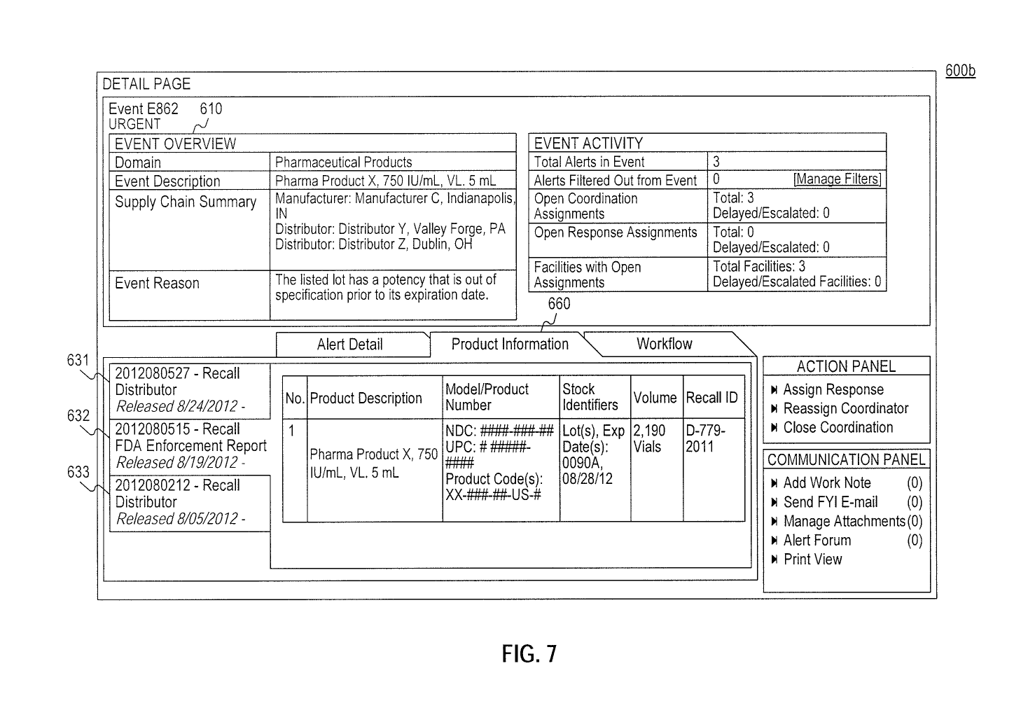

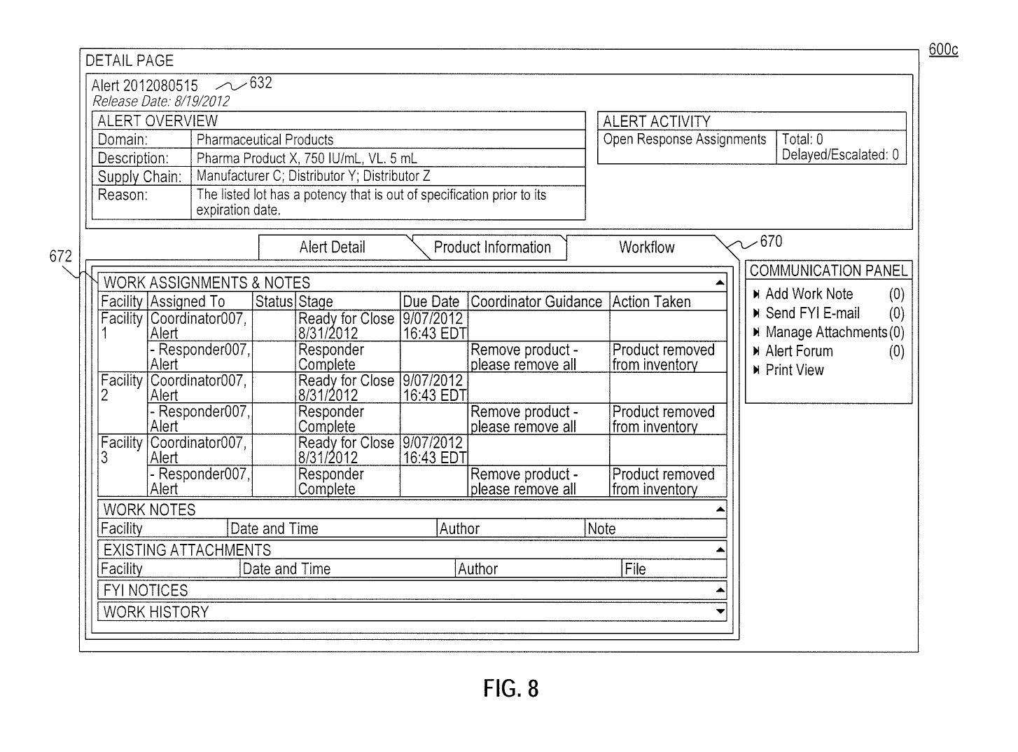

FIGS. 7 and 8 show additional exemplary screen shots of GUI 600a that may be generated by product event manager 110 and displayed to the user to track the progress of various workflows and responsive actions associated with the product alerts, in order to ensure the product alerts included in a product event are properly handled. This may enable a user, such as a coordinator responsible for managing the responsive actions, to close out alerts in a timely and efficient manner.

For example, FIG. 7 illustrates a GUI 600b that may be displayed when a user selects “Product Information” tab 660. As shown in FIG. 7, “Product Information” tab 660 may display a list of the product alerts 631-633 included in the product event. Additionally, GUI 600b shows that product alert 632 has been selected in FIG. 7, causing product event manager 110 to generate data to display, via GUI 600b, product information that is related to the particular alert, such as a product description, model or product number, stock identifiers such as lot numbers and expiration dates, an amount or volume of the product implicated, and a recall identifier that may be issued by the alerting entity.

FIG. 8 illustrates a GUI 600c that may be displayed for a particular product alert, such as product alert 832, when “Workflow” tab 670 is selected for that product alert. For example, window 672 may include a summary of the workflow associated with the product alert, including, for each facility implicated by the product alert, a listing of the responsible responder and coordinator, and documentation of the steps that need to be taken to close the alert as well as the progress made toward completing each of these steps. A user may consult “Workflow” tab 670 to determine when a product alert can be closed, for example.

The foregoing descriptions have been presented for purposes of illustration and description. They are not exhaustive and do not limit the disclosed embodiments to the precise form disclosed. Modifications and variations are possible in light of the above teachings or may be acquired from practicing the disclosed embodiments. For example, the described implementation includes software, but the disclosed embodiments may be implemented as a combination of hardware and software or in firmware. Examples of hardware include computing or processing systems, including personal computers, servers, laptops, mainframes, micro-processors, and the like. Additionally, although disclosed aspects are described as being stored in a memory on a computer, one skilled in the art will appreciate that these aspects can also be stored on other types of computer-readable storage devices, such as secondary storage devices, like hard disks, floppy disks, a CD-ROM, USB media, DVD, or other forms of RAM or ROM.

Other embodiments will be apparent to those skilled in the art from consideration of the specification and practice of the embodiments disclosed herein. The recitations in the claims are to be interpreted broadly based on the language employed in the claims and not limited to examples described in the present specification or during the prosecution of the application, which examples are to be construed non-exclusive. Further, the steps of the disclosed methods may be modified in any manner, including by reordering, combining, separating, inserting, and/or deleting steps. It is intended, therefore, that the specification and examples be considered as exemplary only, with a true scope and spirit being indicated by the following claims and their full scope equivalents.

What is claimed is:

1. A computer system for processing and managing a plurality of product events, each product event being related to a plurality of product alerts for one or more products, the system comprising:
one or more memories storing computer instructions; and
one or more computer processors configured to execute the instructions to perform operations including:
receiving a first product alert corresponding to a product event, wherein the product event is one of a recall event, a field correction event, or a repair instructions event;
receiving a second product alert;
determining that the second product alert corresponds to the product event; and
responsive to determining that the second product alert corresponds to the product event, generating an event data entry in a database that represents the product event and includes the first product alert and the second product alert.

2. The system of claim 1, the one or more computer processors being further configured to perform operations including:
receiving a third product alert that also corresponds to the product event; and
adding the third product alert to the event data entry.

3. The system of claim 1, the one or more computer processors being further configured to perform operations including:
receiving instructions that actions were taken in response to the second product alert; and
updating the event data entry to reflect the actions taken in response to the second product alert.

4. The system of claim 1, the one or more computer processors being further configured to perform operations including:
assigning an open status to the event data entry;
receiving instructions that an action was taken in response to the second product alert and that the second product alert should be closed; and
responsive to receiving the instructions, assigning a closed status to the event data entry.

5. The system of claim 4, the one or more computer processors being further configured to perform operations including:
receiving a third product alert that also corresponds to the product event;
adding the third product alert to the event data entry and assigning an open status to the event data entry;
receiving updated instructions that an action was taken in response to the third product alert and that the third product alert should be closed; and
assigning a closed status to the event data entry responsive to receiving the updated instructions.

6. The system of claim 4, the one or more computer processors being further configured to perform operations including:
receiving a third product alert that also corresponds to the product event;
determining that the third product alert satisfies a filtering criterion;
adding the third product alert to the event data entry; and
generating an instruction to maintain the status of the event data entry based on the determination that the third product alert satisfies the filtering criterion.

7. The system of claim 1, wherein the event data entry includes a number of product alerts included in the event data entry and a status identifier reflecting the status of the event data entry.

8. The system of claim 7, the one or more computer processors being further configured to perform operations including:
generating data to display a graphical user interface including the number of product alerts included in the event data entry, the status identifier reflecting the status of the event data entry, and each product alert included in the event data entry.

9. A computer-implemented method for processing and managing a plurality of product events, each product event being related to a plurality of product alerts for one or more products, the method comprising:
receiving, by one or more computer processors, a first product alert corresponding to a product event, wherein the product event is one of a recall event, a field correction event, or a repair instructions event;
receiving, by the one or more computer processors, a second product alert;
determining, by the one or more computer processors, that the second product alert corresponds to the product event;
responsive to determining that the second product alert corresponds to the product event, generating, by the one or more processors, an event data entry in a database that represents the product event and includes the first product alert and the second product alert; and
generating data to display a graphical user interface that includes workflow information for both the first product alert and the second product alert.

10. The computer-implemented method of claim 9, further comprising:
receiving a third product alert that also corresponds to the product event; and
adding the third product alert to the event data entry.

11. The computer-implemented method of claim 9, further comprising:
receiving instructions that actions were taken in response to the second product alert; and
updating the event data entry to reflect the actions taken in response to the second product alert.

12. The computer-implemented method of claim 9, further comprising:
assigning an open status to the event data entry;
receiving instructions that an action was taken in response to the second product alert and that the second product alert should be closed; and
responsive to receiving the instructions, assigning a closed status to the event data entry.

13. The computer-implemented method of claim 12, further comprising:
receiving a third product alert that also corresponds to the product event;
adding the third product alert to the event data entry and assigning an open status to the event data entry;
receiving updated instructions that an action was taken in response to the third product alert and that the third product alert should be closed; and
assigning a closed status to the event data entry responsive to receiving the updated instructions.

14. The computer-implemented method of claim 12, further comprising:
receiving a third product alert that also corresponds to the product event;
determining that the third product alert satisfies a filtering criterion;
adding the third product alert to the event data entry; and
generating an instruction to maintain the status of the event data entry based on the determination that the third product alert satisfies the filtering criterion.

15. The computer-implemented method of claim 9, wherein the event data entry includes a number of product alerts included in the event data entry and a status identifier reflecting the status of the event data entry.

16. The computer-implemented method of claim 15, wherein the graphical user interface displays the number of product alerts included in the event data entry, the status identifier reflecting the status of the event data entry, and each product alert included in the event data entry.

17. A system for processing and managing a plurality of product events, each product event being related to a plurality of product alerts for one or more products, the system comprising:
one or memories storing instructions; and
one or more processors configured to execute the instructions to perform operations including:
determining that each of a plurality of product alerts corresponds to a product event, wherein the product event is one of a recall event, a field correction event, or a repair instructions event related to the product;
generating an event data entry for the product event that includes the plurality of product alerts; and
providing data to generate a graphical user interface that displays the event data entry and enables a user to update a workflow associated with each of the plurality of product alerts, wherein the graphical user interface updates a displayed status of the event data entry based on updates to the workflow associated with each of the plurality of product alerts.

18. The system of claim 17, the one or more processors being further configured to execute the instructions to perform operations including:
displaying, via the graphical user interface, that the event data entry has an open status;
receiving, via the graphical user interface, instructions that an action was taken in response to the second product alert and that the second product alert can be closed; and
displaying, via the graphical user interface, that the event data entry has a closed status.

19. The system of claim 18, the one or more processors being further configured to perform operations including:
receiving a subsequent product alert that also corresponds to the product event;
displaying, via the graphical user interface, the subsequent product alert included within the event data entry;
displaying, via the graphical user interface, that the event data entry has an open status;
receiving, via the graphical user interface, instructions that another action was taken in response to the subsequent product alert and that the subsequent product alert can be closed; and
displaying, via the graphical user interface, that the event data entry has a closed status.

20. The system of claim 18, the one or more processors being further configured to perform operations including:
receiving, via the graphical user interface, a filtering criterion for filtering out product alerts;
receiving a subsequent product alert that also corresponds to the product event;
determining that the subsequent product alert satisfies the filtering criterion;
displaying, via the graphical user interface, the subsequent product alert included within the event data entry; and
displaying, via the graphical user interface, that the event data entry has a closed status based on the determination that the third product alert satisfies the filtering criterion.
